(19) United States
(12) Patent Application Publication
(10) Pub. No.: US 2004/0206215 A1
(43) Pub. Date: Oct. 21, 2004

(54) Screwdriver for high torque situations

(76) Inventors: Theodoros Athanasiou, Toronto (CA); Andreas Athanasiou, Flushing, NY (US)

Correspondence Address: ATHANASIOU ANDREAS, 4266 PHLOX PLACE, APT A4, FLUSHING, NY, 11355, US

(21) Appl. No.: 10/419,335

(22) Filed: Apr. 21, 2003

(51) Int. Cl. B25B 23/16

(52) U.S. Cl. 81/177.5

(57) ABSTRACT

An improved screwdriver including a shank with a hole at the bottom end. A shaft can be introduced in this hole during operation, so that the user can use this shaft to apply addition torque through the screwdriver.

### BACKGROUND OF INVENTION

1. Field of the Invention

The present invention generally relates to tools and other devices generally used in the fields of construction and carpentry, and specifically to a screwdriver.

2. Description of the Prior Art

Conventional screwdrivers are simple and sturdy in design, and sufficient torque for most applications can be applied through them to the screw by the simultaneous turning and downwards pressure applied by the operator. In many cases however, not enough torque can be applied through prior art in the field of screwdrivers, resulting in screws that are not fully inserted (requiring the removal of said screw and the re-introduction of a thinner screw), or screws that can't be removed (requiring means of destroying the said screw).

The prior art in the field of screwdrivers teach several complex improvements and variations of screwdrivers and components used for increasing the amount of torque applied to the screw. However, the prior art does not teach a screwdriver shankt and shaft as taught by the present invention.

Consequently, the primary object of the present invention is to provide a simple improvement by which a screwdriver can be used with increase torque.

### SUMMARY OF INVENTION

The present invention involves a screwdriver having a shank having dimensions of length greater than width, with a hole closest to the end that would be applied to the screw. The present invention also has a shaft, with dimensions of length greater than width, that can be temporary inserted into the hole of the shank, forming a point that the user can apply additional torque. The components and their arrangement combine to form the present invention, a compact, high torque screwdriver that is user-friendly, and cost-efficient manufacturing.

### BRIEF DESCRIPTION OF DRAWINGS

The present invention as described in this specification will be more fully understood when taken in conjunction with the drawings appended hereto, wherein:

FIG. 1 shows a side view of the present invention with all the components.

FIG. 2 shows a top view of the present invention with all the components as they would be arranged during the application of additional torque.

### DETAILED DESCRIPTION

The present invention is directed towards a screwdriver having a shank with a hole, through which a shaft can be inserted. The basic components of the present invention are a shank with a hole at the bottom end of it, and a shaft which will fit through the hole of the shank. The combination and the arrangement thereof, form a screwdriver that is particularly affective and efficient in design that can be used when high torque needs to be applied to a screw.

It is an object of the present invention to provide a screwdriver that has enhanced torque characteristics.

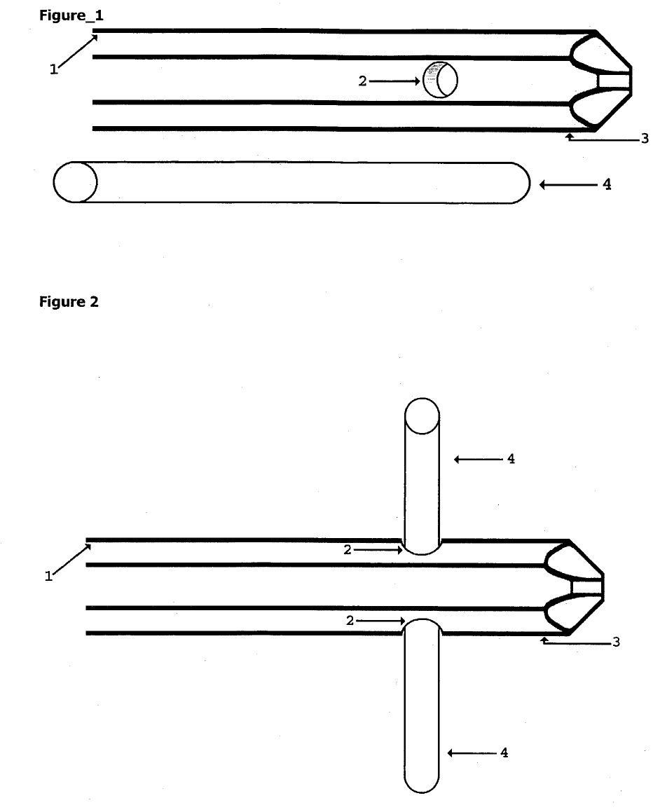

Referring now to FIG. 1, there is shown a side view of the present invention screwdriver having a shank with first end 1, second end 3, a hole 2 close to the second end 3. The detachable shaft 4 is shown at a detached composition. Both shank 1 and shaft 4 have dimensions of length greater then width. The hole 2 on shank 1 is of diameter such that shaft 4 would fit through.

Referring now to FIG. 2, there is shown a top view of a present invention screwdriver having a shank with first end 1, second end 3, a hole 2 close to the second end 3. The detachable shaft 4 is shown at an attached composition. Both shank 1 and shaft 4 have dimensions of length greater then width. The hole 2 on shank 1 is of diameter such that shaft 4 would fit through.

The components of this screwdriver and their arrangement combine to form the present invention that is user-friendly, and cost-efficient for manufacturing.

Obviously, numerous modifications and variations of the present invention are possible in light of the above teachings. It is therefore understood that within the scope of the

1. A screwdriver shank having first end (labeled 1 in FIG. 1) and second end (labeled 3 in FIG. 1).

2. Said second end having a hole (labeled 2 in FIG. 1).

3. A removable shaft (labeled 4 in FIG. 1) fitting into said hole (claim 2) in the said shank (claim 1).
